(19) United States
(12) Patent Application Publication
(10) Pub. No.: US 2014/0322379 A1
(43) Pub. Date: Oct. 30, 2014

(54) EXTRUSION MOLDING DEVICE

(71) Applicant: HON HAI PRECISION INDUSTRY CO., LTD., New Taipei (TW)

(72) Inventor: CHIA-LING HSU, New Taipei (TW)

(73) Assignee: HON HAI PRECISION INDUSTRY CO., LTD., New Taipei (TW)

(21) Appl. No.: 14/067,954

(22) Filed: Oct. 31, 2013

(30) Foreign Application Priority Data
Apr. 29, 2013 (TW) 102115193

(51) Int. Cl. B29D 11/00

(52) U.S. Cl. CPC B29D 11/00721
USPC 425/174.4; 425/380

(57) ABSTRACT

An extrusion molding device includes a first roller, a second roller, an ejecting source, a guiding element, and a prism molding system. The second roller is located adjacent to the first roller. The injecting source is located above the first roller and the second roller. The guiding element is located at a side of the second roller away from the first roller. The prism molding system is located at a side of the guiding element away from the second roller.

### BACKGROUND

1. Technical Field

The present disclosure relates to molding devices, and particularly to an extrusion molding device.

2. Description of Related Art

Liquid crystal displays include a liquid crystal module and a light guide module for guiding light rays onto the liquid crystal module. The light guide module is formed by injection molding and includes a light guide plate, which includes microstructures. To reduce a size of the light guide plate, the light guide plate is made thinner and thinner and may be rapidly cooled, which results in the microstructures not efficiently transferring onto the light guide plate.

Therefore, it is desirable to provide an extrusion molding device, which can overcome the limitations described.

### BRIEF DESCRIPTION OF THE DRAWINGS

FIG. 1 is an isometric view of an extrusion molding device in accordance with a first exemplary embodiment.

FIG. 2 is a cross-sectional view of a light guide plate molded by the extrusion molding device of FIG. 1.

FIG. 3 is an isometric view of an extrusion molding device in accordance with a second exemplary embodiment.

### DETAILED DESCRIPTION

Embodiments of the disclosure will be described with reference to the drawings.

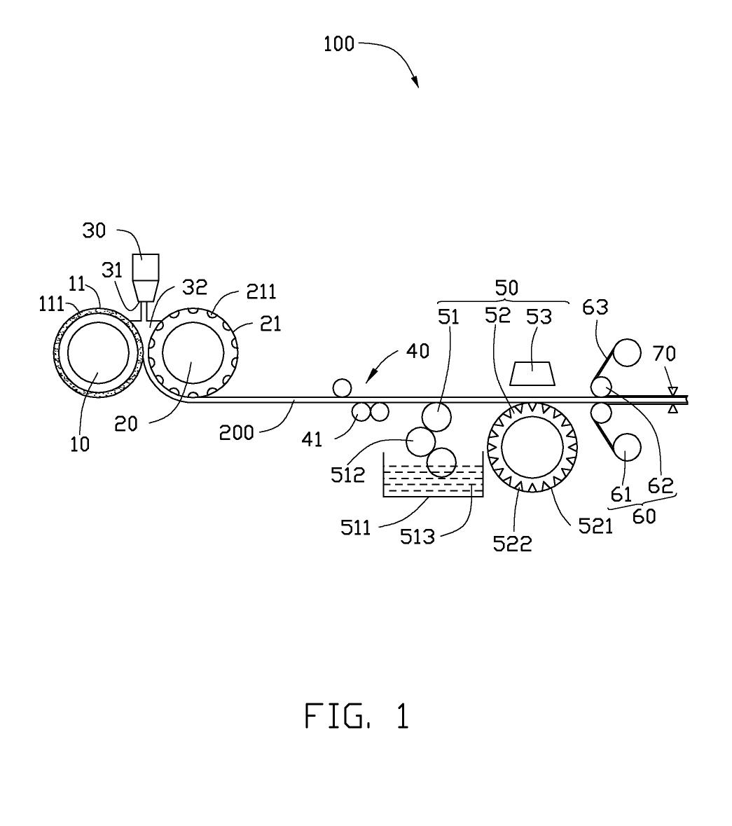

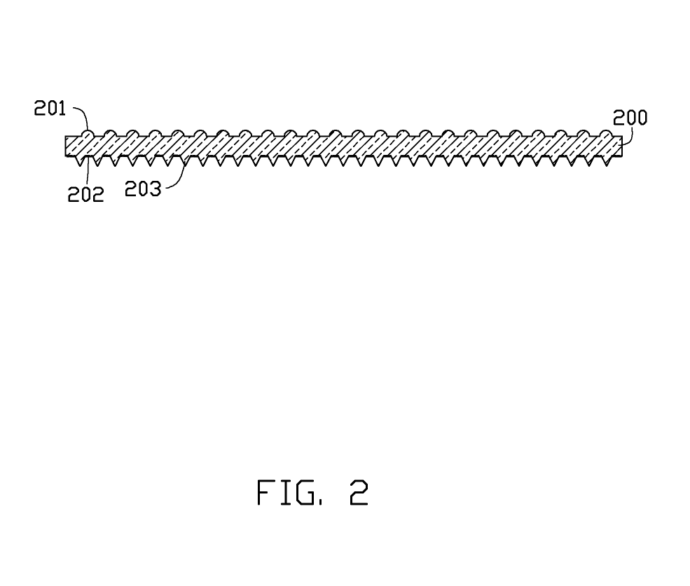

FIGS. 1-2 show an extrusion molding device 100 used to mold a light guide plate 200, according to a first exemplary embodiment. The extrusion molding device 100 includes a first roller 10, a second roller 20, an injecting source 30, a guiding element 40, a prism molding system 50, a protection film system 60, and a cutting device 70.

The first roller 10 includes a first cylindrical surface 11, and a first pattern 111 is formed on the first cylindrical surface 11 via a precision sand blasting system. The first roller 10 is coupled to a first driver, and the first driver drives the first roller 10 to rotate along a clockwise direction at a constant velocity.

The second roller 20 is located adjacent to the first roller 10. A thickness of the light guide plate 200 is adjusted by adjusting a minimum distance between the first roller 10 and the second roller 20. The second roller 20 includes a second cylindrical surface 21, and a second pattern 211 is formed on the second cylindrical surface 21 via a fast axis machining system. The second roller 20 is coupled to a second driver, and the second driver drives the second roller 20 to rotate along a counter clockwise direction at a velocity substantially equal to that of the first roller 10.

The injecting source 30 is located above the first roller 10 and the second roller 20 and is equidistant between the first roller 10 and the second roller 20. The injecting source 30 includes an ejecting hole 31 facing the first roller 10 and the second roller 20. The injecting source 30 ejects a molten resin 32 through the ejecting hole 31 toward the first roller 10 and the second roller 20.

The guiding element 40 is located at a side of the second roller 20 away from the first roller 10. The guiding element 40 includes at least two guiding wheels 41. In the embodiment, there is at least one guiding wheel 41 on each side of the light guide plate 200. The guiding wheels 41 adjacent to an upper portion of the light guide plate 200 rotates along a counter clockwise direction, while the guiding wheels 41 adjacent to a lower portion of the light guide plate 200 rotates along a clockwise direction.

The prism molding system 50 is located at a side of the guiding element 40 away from the second roller 20. The prism molding system 50 includes a rolling system 51, a prism roller 52, and an ultraviolet light source 53. The rolling system 51 is located between the guiding element 40 and the prism roller 52. The ultraviolet light source 53 is located above the prism roller 52, and the ultraviolet light source 53 and the prism roller 52 are spaced from each other.

The rolling system 51 includes a receiver 511 and a number of transmitting rollers 512. An ultraviolet glue 513 is received in the receiver 511. A part of one of the transferring rollers 512 is received in the receiver 511 and contacts the ultraviolet glue 513. The transferring rollers 512 roll against each other to transfer the ultraviolet glue 513 to each other.

The prism roller 52 includes a third cylindrical surface 521, and a V-shaped recess pattern 522 is formed on the ultraviolet light source 53 via an ultra-precision machining tool. The prism roller 52 is coupled to a third driver, and the third driver drives the prism roller 52 to rotate along a clockwise direction at a constant velocity.

The ultraviolet light source 53 faces the prism roller 52 and projects ultraviolet light rays onto the prism roller 52. The ultraviolet glue 513 is solidified under irradiation of the ultraviolet light rays.

The protection film system 60 is located at a side of the prism roller 52 away from the rolling system 51. The protection film system 60 includes a lower covering portion 61 and an upper covering portion 62 opposite to the lower covering portion 61. The lower covering portion 61 and the upper covering portion 62 are spaced from each other and are configured to coat different or same protecting films 63 onto the molded light guide plate 200.

The cutting device 70 is located at a side of the protection film system 60 away from the prism roller 52. The cutting device 70 is configured to cut the light guide plate 200 molded by the extrusion molding device 100 to a preset size. The cutting device 70 is controlled by a machine (not shown).

In molding the light guide plate 200, the molten resin 32 is ejected between the first roller 10 and the second roller 20. The molten resin 32 is extruded into the light guide plate 200 by the first roller 10 and the second roller 20. Because an adhesive force between the light guide plate 200 and the second roller 20 is greater than an adhesive force between the light guide plate 200 and the first roller 10, the light guide plate 200 adheres to the second roller 20. The light guide plate 200 includes a roughened surface 201 formed by the first pattern 111 and a netted dots surface 202 formed by the second pattern 211. The roughened surface 201 is opposite to the netted dots surface 202.

The guiding rollers 41 of the guiding element 40 are located at opposite sides of the light guide plate 200 to guide the light guide plate 200 to the rolling system 51. One of the transferring rollers 512 contacts the roughened surface 201 of the light guide plate 200. A layer of ultraviolet glue 513 is rolled onto the roughened surface 201 by the transmitting roller 512. When the light guide plate 200 passes by the prism roller 52 and the ultraviolet light source 53, the layer of ultraviolet glue 513 contacts the prism roller 52, thereby forming a prism structure 203 on the ultraviolet glue 513. The prism structure 203 is solidified under the ultraviolet light rays emitted from the ultraviolet light source 53. The light guide plate 200 is further guided from the prism molding system 50 to the protection film system 60. The light guide plate 200 passes through the upper covering portion 61 and the lower covering portion 62, and the upper covering portion 61 and the lower covering portion 62 cover the protecting films 63 on the netted dots surface 202 and the prism structure 203 of the light guide plate 200. The cutting device 70 cuts the light guide plate 200 passing through the protection film system 60 to a preset size.

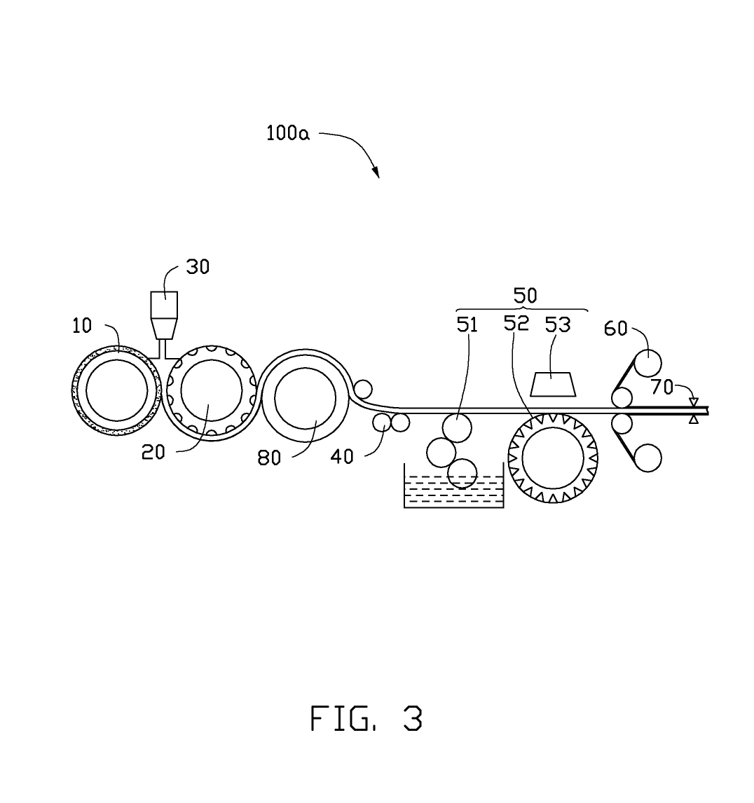

FIG. 3 shows an extrusion molding device 100a, according to a second exemplary embodiment. The extrusion molding device 100a of FIG. 3 is similar to the extrusion molding device 100 of FIG. 1, except that the extrusion molding device 100a further includes a cooling roller 80. The cooling roller 80 is located between the second roller 20 and the guiding element 40 and is configured for cooling the light guide plate 200.

Particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. An extrusion molding device, comprising:
a first roller;
a second roller located adjacent to the first roller;
an injecting source located above the first roller and the second roller;
a guiding element located at a side of the second roller away from the first roller; and
a prism molding system positioned at a side of the guiding element away from the second roller;
wherein when a molten resin is ejected from the injecting source, the molten resin is pressed into a light guide plate by the first roller and the second roller, the light guide plate comprises a roughened surface molded by the first roller and a netted dots surface molded by the second roller, the guiding element then guides the light guide plate from the second roller to the prism molding system, the prism molding system molds a prism structure on the netted dots surface.

2. The extrusion molding device of claim 1, wherein the first roller rotates in a direction reverse to a rotation direction of the second roller, and the first roller and the second roller have the same rotational velocity.

3. The extrusion molding device of claim 1, wherein the guiding element comprises at least two guiding wheels, at least one of the least two guiding wheels is located at on each side of the light guide plate.

4. The extrusion molding device of claim 3, wherein the at least one guiding wheel adjacent to an upper portion of the light guide plate rotates in a direction reverse to a rotation direction of the at least one guiding wheel adjacent to a lower portion of the light guide plate.

5. The extrusion molding device of claim 1, wherein the prism molding system comprises a rolling system, a prism roller, and an ultraviolet light source; the rolling system is located between the guiding element and the prism roller; the ultraviolet light source is located above the prism roller, and the ultraviolet light source and the prism roller are spaced from each other.

6. The extrusion molding device of claim 5, wherein the rolling system comprises a receiver and a plurality of transferring rollers, an ultraviolet glue is received in the receiver, a part of one of the transferring rollers is received in the receiver and contacts with the ultraviolet glue.

7. The extrusion molding device of claim 6, wherein the transmitting roller is configured for coating a layer of ultraviolet glue on the roughened surface.

8. The extrusion molding device of claim 1, comprising a cooling roller, wherein the cooling roller is located between the second roller and the guiding element, and is configured for cooling the light guide plate.

9. The extrusion molding device of claim 1, comprising a protection film system, wherein the protection film system is located at a side of the prism molding system away from the guiding element, and is configured for covering protection films on the light guide plate.

10. The extrusion molding device of claim 9, wherein the protection film system comprises an upper covering portion and a lower covering portion opposite to the upper covering portion; the upper covering portion and the lower covering portion are spaced apart from each other, and are configured for covering different or same protection films.

11. The extrusion molding device of claim 10, comprising a cutting device, wherein the cutting device is located at a side of the protection film system away from the prism molding system, the cutting device is configured for cutting the light guide plate to a preset size.
